(19) United States
(12) Patent Application Publication
(10) Pub. No.: US 2004/0254772 A1
(43) Pub. Date: Dec. 16, 2004

(54) Method to construct models for vehicle road load simulations

(75) Inventor: Hong Su, Windsor (CA)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/459,966

(22) Filed: Jun. 12, 2003

(51) Int. Cl. G06G 7/48

(52) U.S. Cl. 703/8

(57) ABSTRACT

The present invention relates to a method for constructing a representative time domain road load profile or model for computer aided engineering simulation of an automotive product. The model is based on the dynamic characteristics of the product and the statistical properties of the proving ground road load data from the field

### BACKGROUND

1. Technical Field

The present invention relates generally to computer aided engineering simulation of automotive products, and more particularly relates to constructing a representative time domain road load profile for CAE simulations.

2. Background Information

In the automotive industry, computer aided engineering (“CAE”) simulation is increasingly employed to evaluate a product for structural integrity, durability, and design life, under proving ground test load environments. Compared with physical tests, CAE simulation can make product development faster and better at lower costs, especially at the early design stage before a prototype is built.

However, confidence in the CAE simulation, in an addition to the fidelity of the modeled structure, is dependent on the road load model representation of the proving ground test environment. For a typical vehicle proving ground test, there are several road load events with different road surface profiles, traveling speeds, and durations. The total vehicle test time duration for a physical test is around several hundred hours. However, it is not practical to simulate this entire test duration on a computer simulation because of limited computational resources, in terms of time, space and costs.

To reduce the simulation time, many current road load modeling methods are based on a worst load case approach which takes a segment of the most severe load event of the proving ground data and disregards all other load events. However, these approaches may cause significant errors because the frequency content of the discarded load events may induce large stress in the product, which, in turn, could be the driving factor in determining the failure of the product. In addition, the damage due to the proving ground road load environment includes the damage from all the major road load events and the related durations. Thus, by discarding certain events, the current road load modeling methods do not consider the damages contributed from all major road load events.

From the above, it is seen that there exits a need for an improved CAE simulation model that considers all the major proving ground load events in a simulation that can be performed within a practical time period.

### BRIEF SUMMARY

In overcoming the above mentioned and other drawbacks, the present invention provides a computer aided engineering model that represents all the major proving ground load events. Moreover, the time duration of the proving ground load simulation with the model is within practical time limits.

In general, the present invention relates to a method for constructing a representative road load profile or model for computer aided engineering simulations of an automotive product based on proving ground road load data from the field. The profile or model is based on the dynamic characteristics of the product and the statistical properties of the proving ground road load data.

While the physical proving ground road load has a typical duration of several hundred hours, the constructed computer aided engineering simulation road load model has a duration of only a few minutes. In other words, the field proving ground load environment is simulated by a constructed road load profile model which is much shorter in time duration, making the computer aided engineering computation with the constructed model both practical and economical. The total damage caused by the proving ground load may be estimated to be equivalent to the product of the damage from one computer aided engineering simulation and the duration ratio of the proving ground time duration to the computer aided engineering simulation time duration.

The foregoing discussion has been provided only by way of introduction. Nothing in this section should be taken as a limitation on the following claims, which define the scope of the invention.

### BRIEF DESCRIPTION OF THE DRAWINGS

The accompanying drawings, incorporated in and forming a part of the specification, illustrate several aspects of the present invention and, together with the description, serve to explain the principles of the invention. The components in the figures are not necessarily to scale, emphasis instead being placed upon illustrating the principles of the invention. Moreover, in the figures, like reference numerals designate corresponding parts throughout the views. In the drawings:

FIG. 1 is a flow diagram of a sequence of steps performed in accordance with the present invention in a computer aided engineering simulation;

FIG. 2A depicts a finite element model of an instrument panel assembly;

FIG. 2B depicts a computer aided engineering virtual test configuration for the instrument panel;

FIG. 3A depicts the X-component data of the acceleration load of passenger cars on a basic durability road;

FIG. 3B depicts the Y-component data of the acceleration load of passenger cars on a basic durability road;

FIG. 3C depicts the Z-component data of the acceleration load of passenger cars on a basic durability road;

FIG. 4A depicts the Z-component data of the PSD of the acceleration load of passenger cars on a basic durability road;

FIG. 4B depicts the Z-component data of the PSD of a truncated acceleration load of passenger cars on a basic durability road;

FIG. 5A depicts the X-component of the acceleration load of passenger cars on a resonance impact road;

FIG. 5B depicts the Y-component of the acceleration load of passenger cars on a resonance impact road;

FIG. 5C depicts the Z-component of the acceleration load of passenger cars on a resonance impact road;

FIG. 6A depicts the Z-component of the PSD of the acceleration load of passenger cars on a resonance impact road;

FIG. 6B depicts the Z-component of the PSD of a truncated acceleration load of passenger cars on a resonance impact road;

FIG. 7A depicts the X-component of the acceleration load of passenger cars on a cobblestone road;

FIG. 7B depicts the Y-component of the acceleration load of passenger cars on a cobblestone road;

FIG. 7C depicts the Z-component of the acceleration load of passenger cars on a cobblestone road;

FIG. 8A depicts the Z-component of the PSD of the acceleration load of passenger cars on a cobblestone road;

FIG. 8B depicts the Z-component of the PSD of a truncated acceleration load of passenger cars on a cobblestone road;

FIG. 9A depicts the X-component of the acceleration load of the constructed data of passenger cars;

FIG. 9B depicts the Y-component of the acceleration load of the constructed data of passenger cars; and

FIG. 9C depicts the Z-component of the acceleration load of the constructed data of passenger cars.

### DETAILED DESCRIPTION

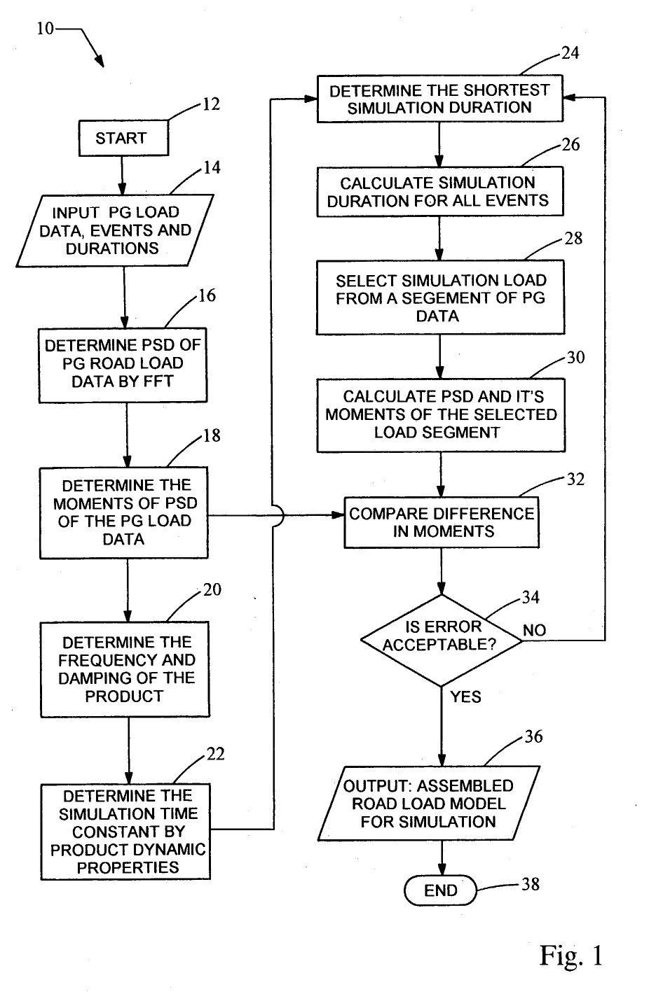

In accordance with the invention, FIG. 1 illustrates a process 10 for constructing a road load profile for computer aided engineering (“CAE”) simulation of an automotive product based upon the dynamic characteristics of the product and the statistical properties of the proving ground road load data.

After initializing in step 12, the process 10 receives input data in step 14, such as proving ground load data and time durations of the load events. The process 10 in step 16 performs a fast Fourier transform (FFT) on the road load data G_{di}(t) that is in the time domain t, where the subscript d identifies the three mutually perpendicular directions X, Y, and Z and i (i=1, 2, . . . , N) identifies the individual load road event of N number of events. As such, step 16 determines the dynamic characteristics of the proving ground road loads in the frequency domain f for each proving ground load event i (i=1, 2, . . . N) in terms of a power spectral density function PSD_{di}(f).

In step 18, the process 10 determines the statistical properties of each road load event for each component d by calculating the moments M_{din} (n=1, 2, 3, 4) of the power spectral density function PSD_{di}(f) (i=1, 2, . . . N; d=X, Y, Z), as represented by the expression

$${M}_{din} = {\int }_{0}^{∞} {f}^{n} {PSD}_{di} ( f ) ⅆ f \qquad ( 1 )$$

Subsequently, the process 10 determines, in step 20, the basic dynamic characteristics of the structure of the product in terms of the natural frequency fₙ₁ and the equivalent damping coefficient ζₙ₁ of the first major mode.

In step 22, the process 10 then selects an allowable error δ (or settling error) due to the transient response with respect to the steady state time domain simulation requirement and then calculates the allowable simulation time constant (or response settling time constant) τₛₘ from the relationship

$${τ}_{sm} = \frac{ln ( \frac{1}{δ} )}{2 π {f}_{n1} {ζ}_{n1}} \qquad ( 2 )$$

Next, the process 10, in step 24, develops the simulation time duration Tₛₒ for the shortest proving ground event according to the expression

Tₛₒ≧ατₛₘ (3)

based on a selected steady state factor α and the simulation time constant τₛₘ. Thus, the minimum CAE simulation time is based on the dynamic characteristic of the product structure, the allowable settling error, the steady state factor, and the settling time.

In step 26, the process 10 calculates the simulation time durations Tₛᵢ(i=1, 2, . . . N) for all of the events, corresponding to their respective scheduled proving ground event durations T_{Ei}(i=1, 2, . . . N), based on the constraint on the minimum simulation duration Tₛₒ according to the expression

$${T}_{si} = [ \frac{( {\sum }_{i = 1}^{N} {T}_{si} )}{( {\sum }_{i = 1}^{N} {T}_{Ei} )} ] {T}_{Ei} , i = 1 , 2 , 3 , … , N \qquad ( 4 )$$

where the shortest simulation duration Tₛₘ is set equal to Tₛₒ, namely,

Tₛₘ=Tₛₒ, for T_{Em}=min(T_{Ei}, i=1, 2, 3, . . . , N) (5)

and where the time duration T_{Ei} of each proving ground event is estimated from the travel distance of the event Dₒᵢ, the repeated test times mᵢ, and the average traveling speed vₐᵢ from the expression:

$$\begin{matrix}{T}_{Ei} = \frac{{m}_{i} {D}_{oi}}{{v}_{ai}} , & i = 1 , 2 , 3 , … , N\end{matrix} \qquad ( 4 )$$

In step 28, the process 10 selects the simulation time domain load G_{sdi}(t) with a duration Tₛᵢ from a segment of the original proving ground road load data G_{di}(t) as a representative of each proving ground event (for i=1, 2, . . . N and d=X, Y, Z). This automatic process or trial-and-error process selects a segment of the load profile which meets the requirements for representing the given event load profile in terms of the load statistical characteristics.

Subsequently, in step 30, the process 10 uses the fast Fourier transforms to calculate the power spectral density function PSD_{sdi}(f) for each proving ground event i (i=1, 2, . . . N) of the selected simulation load G_{dsi}(t) with the simulation time Tₛᵢ, and also calculates the corresponding moments M_{sdin} (n=1, 2, 3, 4) of the power spectral density function PSD_{sdi}(f) (d=X, Y, Z) according to the expression

$${M}_{sdin} = {\int }_{0}^{∞} {f}^{n} {PSD}_{sdi} ( f ) ⅆ f \qquad ( 7 )$$

In step 32, the process 10 compares the similarity of the constructed road load profile for the CAE simulation with the original proving ground data in terms of the statistical properties determined in step 18. That is, the moments M_{sdin} from step 18 are compared with the moments M_{din} (n=1, 2, 3, 4) determined in step 30.

Next, in step 34, the process 10 determines if the error for the similarity of each proving ground event is within a selected limit or threshold. If not, the process 10 repeats steps 24, 26, 28, 30, and 32 to produce a newly constructed load profile. This continues until an acceptable CAE road load model is constructed.

When the error does not exceed the selected limits, the constructed road load profile is accepted as a representation of the given proving ground road load environment and is used as the CAE simulation load model. In particular, in step 36, the process 10 assembles all of the individual simulation load profiles to construct a representative road load profile of the given proving ground environment and adjusts the time allocation of each event by shifting the time starting points of the simulation load data. The total simulation time duration Tₛ is calculated from the expression:

$${T}_{s} = {\sum }_{i = 1}^{N} {T}_{si} \qquad ( 8 )$$

Finally, the process 10 ends in step 38. The total damage DA_{T} caused by the proving ground load can be estimated from the product of the damage DA_{CAE} due to one CAE simulation and the duration ratio R_{T} given by the expression:

$${R}_{T} = \frac{{T}_{PG}}{{T}_{s}} = \frac{( {\sum }_{i = 1}^{N} {T}_{Ei} )}{( {\sum }_{i = 1}^{N} {T}_{si} )} \qquad ( 9 )$$

where T_{PG} is the total proving ground time duration. Hence, the total damage DA_{T} due to the proving ground load is obtained by:

DA_{T}=DA_{CAE}·R_{T} (10)

In sum, the required minimum CAE simulation time duration is determined from the dynamic characteristics of the product structure and a representative segment road load profile is constructed from the statistical characteristics of each road load event of the proving ground data. Accordingly, the field proving ground road load with a duration of a few hundred hours is represented by the constructed road load model with a duration of only a few minutes. In other words, the field proving ground load environment is simulated by a constructed road load profile model that has a much shorter time duration than that of the field proving ground load environment. Use of such a model makes the CAE computations practical and economical.

While the forgoing discussion provides a broad description of the construction of a simulation model with the process 10, the following discussion describes the application of the process 10 to a specific example. In particular, the process 10 is applied to the construction of a model for an instrument panel assembly of an automotive vehicle based on a proving ground road load schedule. With this constructed model, the CAE simulation can be used for virtual design validation to reduce the time and cost associated with the product development of the instrument panel assembly.

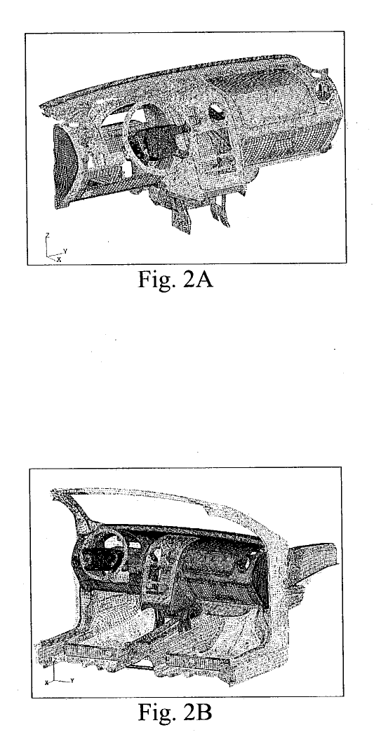

FIG. 2A shows a finite element model of the instrument panel assembly, while FIG. 2B illustrates a test configuration model under the road load model constructed from the process 10. The CAE simulation uses this model as a virtual instrument panel having the same structural configuration as the physical assembly that is subjected to the same dynamic load environment that occurs in the physical validation tests. This enables the engineering team to identify and correct potential durability design problems in the early design stage of the instrument panel before a prototype of the instrument panel is actually built. By employing the CAE virtual tests, the engineers gain insight into the relationship between design parameters and product durability, so that they can provide guidance during the design improvement process.

For this example, the vehicle road load durability schedule, events and duration times for the instrument panel are identified in Table 1 shown below. The road load schedule represents a 150,000 mile, 10 year design reliability requirement for the instrument panel product.

TABLE 1
A Proving Ground Road Load Schedule for Passenger Cars
(For 150,000 Customer Equivalent Miles)

| | | | Driving | | Driving | |
|---|---|---|---|---|---|---|
| Major | Driving | Average | Time | | Dura- | Duration |
| Durability | Distance | Driving | per | Number | tion | Per- |
| Road | per Pass | Speed | Pass | of | Time | centage |
| Events | (Mile) | (MPH) | (Hour) | Passes | (Hour) | (%) |
| Basic | 325 | 55 | 5.91 | 17 | 100 | 65.8 |
| Durability | | | | | | |
| Resonance | 39 | 25 | 1.56 | 17 | 27 | 17.8 |
| Impact | | | | | | |
| Cobble- | 22 | 15 | 1.47 | 17 | 25 | 16.4 |
| stones | | | | | | |
| Total | 386 | | 8.94 | | 152 | 100 |

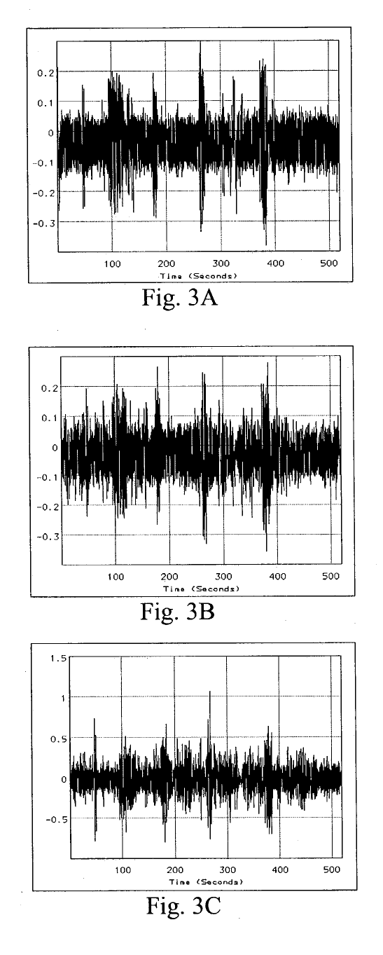

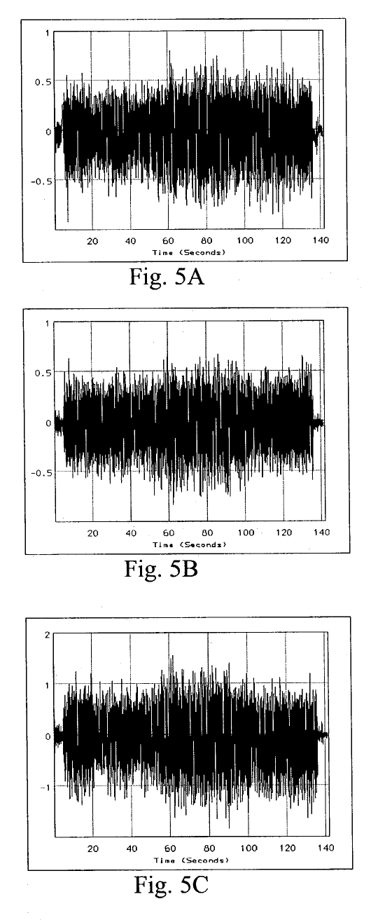

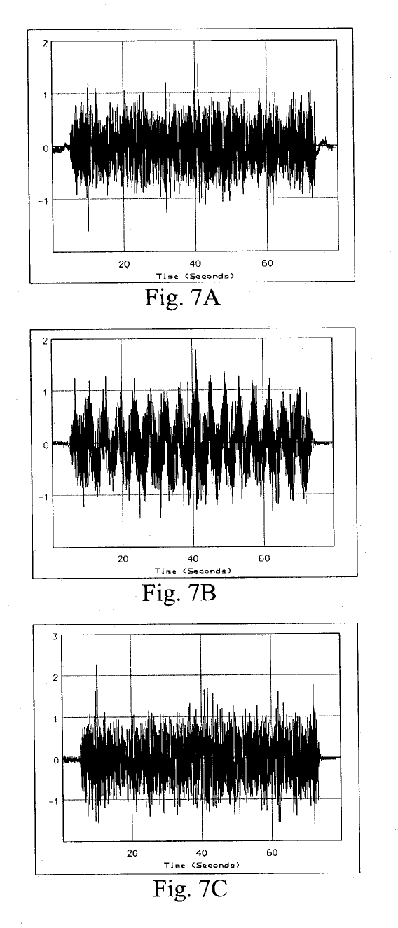

As shown in Table 1, there are typically three major durability road events for a given passenger car, namely: basic durability, resonance impact, and cobblestones. In the physical environment, the total durability tests under the proving ground road loads will last for about 152 hours, with the road loads being measured in three mutually perpendicular directions (X, Y and Z) for each of the road load events. A set of the measured road load data profiles in the time domain are shown in FIGS. 3A-3C, 5A-5C, and 7A-7C, representing the three road events (basic durability, resonance impact, and cobblestones, respectively) for each of the three directions X, Y, Z.

It can be seen in FIGS. 3A-3C, 5A-5C, and 7A-7C that the actual duration of the measured road load data of a road event (in this case 80 to 520 seconds) is much shorter than the scheduled duration, since in the physical durability test the sampled road load data is repeated many times in a complete duration for each event.

However, for the CAE simulation of the virtual durability tests, the process 10 constructs a representative road load profile with as short as duration that is both practical and maintains the fidelity of the model, based on the measured proving ground load data.

The following summarizes the application of the process 10 for the construction of a model for the CAE durability simulation of the instrument panel assembly.

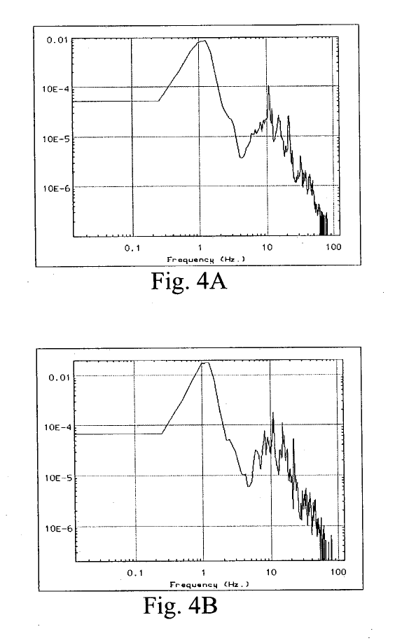

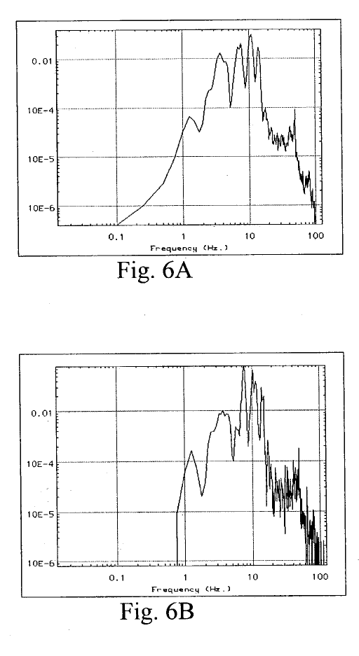

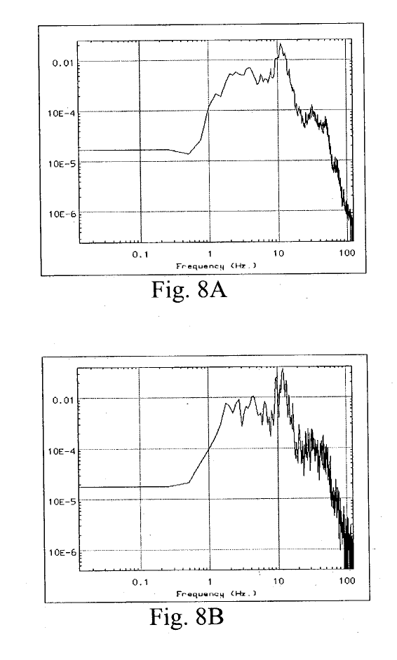

Recall, the process 10 performs a fast Fourier transform on the time domain road load data G_{di}(t) for all three directions (d=X, Y and Z) to determine (step 16) the dynamic characteristics of the proving ground road loads in the frequency domain in terms of the power spectral density function PSD_{di}(f) of each proving ground event i (i=1, . . . N), where for the present example N=3 is the total number of events. For illustrative purposes, the power spectral density profiles in the Z direction are shown in FIGS. 4A, 6A, and 8A for all three road load events, respectively.

The process 10 then determines (step 18) the statistical properties of each road load event in each direction from Equation (1) and then determines (step 20) the basic dynamic characteristics of the instrument panel assembly structure. For this example, the normal mode analysis determines that the first natural frequency of the given instrument panel design is about fₙ₁=25 Hz, and the equivalent damping coefficient of the first major mode is selected as about ζₙ₁=3%, based on the measured damping database for instrument panel products.

Next, the process 10 (step 22) selects the allowable error due to the transient response with respect to the steady state time domain simulation requirement as δ=0.01 and calculates the response settling time constant τₛₘ from Equation (2) as τₛₘ=0.97725 s.

The process 10 (step 24) develops the simulation time duration Tₛₒ for the shortest proving ground event by selecting a steady state factor α=10 and substituting the settling time constant τₛₘ into Equation (3). Accordingly,

Tₛₒ≧ατₛₘ=(10)×(0.97725)=9.7725 sec≈10 sec

Hence, the minimum simulation time for any load event is therefore determined to be about 10 sec in this example.

Subsequently, the process 10 calculates (step 26) from Equations (4) through (6) the simulation time durations Tₛᵢ(i=1, 2, . . . N) for all events, where this example has a total of three events (i.e. N=3). These simulated time durations correspond to their respective scheduled proving ground event durations T_{Ei}(i=1, 2, . . . N) based on the data from Table 1 and the constraint on the minimum simulation duration Tₛₒ.

For example, one set of time durations of the three events for the given road load data is determined to be:

Basic Durability Load, Tₛ₁=39.4 sec;

Resonance Impact Load, Tₛ₂=10.6 sec

Cobblestone Load, Tₛ₃=10.0 sec.

Next, the process 10 (step 28) selects the simulation time domain load G_{sdi}(t) with a duration Tₛᵢ from a segment of the original proving ground road load data G_{di}(t) (for i=1, 2, 3 and d=X, Y, Z) as a representative of each proving ground event.

Then, the process 10 (step 30) uses the fast Fourier transforms to calculate the power spectral density function PSD_{sdi}(f) for each proving ground event i (i=1, 2, . . . N) based on the selected simulation load G_{dsi}(t) with Tₛᵢ and also calculates the corresponding moments M_{sdin} (n=1, 2, 3, 4) of the power spectral density function PSD_{sdi}(f) according to Equation (7). For example, the power spectral density profiles in the Z direction for all three selected segments, corresponding to the given road load events, are shown in FIGS. 4B, 6B, and 8B, respectively.

Subsequently, the process 10 (step 32) compares the similarity of the constructed road load profile for the CAE simulation with the original proving ground data in terms of the statistical properties determined in step 18.

Next, the process 10 (step 34) determines that if the error for the similarity of each proving ground event does not exceed a predetermined or selected limit, the process 10 (step 36) assembles all of the individual simulation load profiles to construct a representative road load profile of the given proving ground environment and adjusts the time allocation of each event by shifting the time starting points of the simulation load data, such that the total simulation time duration Tₛ is 60 sec (1 minute).

If the error is not acceptable, the process 10 repeats a number of steps, as described earlier, until an acceptable CAE road load model is constructed.

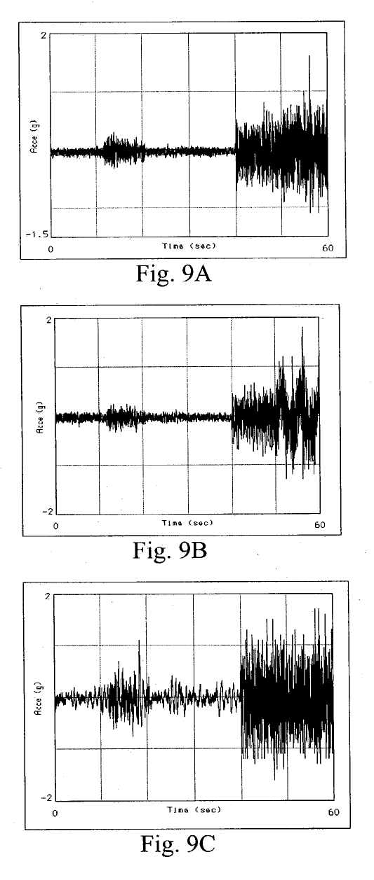

A set of the constructed road load profiles with a 60 second duration for the CAE durability simulation for the given proving ground road load data is shown in FIGS. 9A, 9B, and 9C for the X, Y and Z directions, respectively.

Finally, the duration ratio R_{T} is computed by Equation (9). In this example, the total proving ground time duration is T_{PG}=152 hours (see Table 1) and the total simulation time duration is Tₛ=60 sec (i.e. 1 minute), so that the duration ratio is R_{T}=9120. The total damage DA_{T} caused by the proving ground load is estimated from Equation (10), that is, from the product of the damage DA_{CAE} due to one CAE simulation and the duration ratio R_{T}. The damage DA_{CAE} due to one CAE simulation can be obtained by using a standard fatigue evaluation technique based on stress or strain response to the constructed road load model, which is generated from the process 10.

It is therefore intended that the foregoing detailed description be regarded as illustrative rather than limiting, and that it be understood that it is the following claims, including all equivalents, that are intended to define the spirit and scope of this invention.

What is claimed is:

1. A method of generating a model for computer aided engineering simulations, comprising:
determining the dynamic characteristics and the statistical properties of proving ground data for each road load event of N number of road load events;
determining the minimum simulation duration for each load event based on the dynamic characteristics of the product structure;
selecting simulation load data from the proving ground data based on the minimum simulation duration for each event;
determining the dynamic characteristics and the statistical properties of the simulated load data for each road load event;
comparing the statistical properties of the proving ground data with the statistical properties of the simulated load data, for similarity; and
assembling the simulated load data for all N number of road load events into a constructed road load profile if the comparison between the dynamic characteristics of the proving ground data and the simulated data yields an error that is below an acceptable limit.

2. The method of claim 1 wherein the dynamic characteristics of the proving ground data and the dynamic characteristics of the simulated load data are determined in the frequency domain in terms of a respective power spectral density function for each road load event.

3. The method of claim 2 further comprising calculating the statistical properties in terms of corresponding moments for each power spectral density function for the proving ground data and for the simulated load data.

4. The method of claim 3 further comprising calculating a minimum simulation duration time for the proving ground event with the shortest time.

5. The method of claim 4 further comprising calculating simulation time durations for all of the road load events based on proving ground event durations and the minimum simulation duration time.

6. The method of claim 5 wherein the selected simulated load data for each road load event has a duration corresponding to the respective calculated simulation time duration.

7. The method of claim 5 further comprising calculating a total simulation time duration as a sum of the calculated simulation time durations.

8. The method of claim 7 further comprising determining the total damage caused by the proving ground load as the product due to one simulation time period and the duration ratio of the proving ground time duration to the total simulation time duration.
